(19) United States
(12) Patent Application Publication
(10) Pub. No.: US 2005/0249392 A1
(43) Pub. Date: Nov. 10, 2005

(54) Method for the automatic segmentation of the heart cavities

(76) Inventors: Pascal Raymond Allain, Versailles (FR); Laurent Stefani, Paris (FR); Laurent Launay, Saint Remy Les Chevreuse (FR); Jerome Knoplioch, Neuilly sur Seine (FR)

Correspondence Address: CANTOR COLBURN, LLP, 55 GRIFFIN ROAD SOUTH, BLOOMFIELD, CT, 06002, US

(21) Appl. No.: 11/110,631

(22) Filed: Apr. 20, 2005

(30) Foreign Application Priority Data
Apr. 21, 2004 (FR) 04 50755

(51) Int. Cl. G06K 9/00

(52) U.S. Cl. 382/128; 378/4; 378/19

(57) ABSTRACT

An automatic segmentation of the left or right cavities of the heart muscle is carried out. Once it is decided which cavities have to be isolated, three steps are implemented. A first step is performed to determine which is the volume comprising the cardiac cavities in a volume image resulting from an examination. This first step comprises a thresholding operation and an erosion, and then the determining of the greatest connected component. In a second step, an identification) is made of the left and right cavities. In a third step, a precise reconstruction is made of the contours of the left or right cavities for which it is sought to make the segmentation. The reconstruction is done by the watershed algorithm.

### CROSS-REFERENCE TO RELATED APPLICATIONS

This application claims the benefit of a priority under 35 USC 119(a)-(d) to French Patent Application No. 04 50755 filed Apr. 21, 2004, the entire contents of which is hereby incorporated by reference.

### BACKGROUND OF THE INVENTION

An embodiment of the present invention is a method for the automatic segmentation of the heart cavities. The field of the invention is that of digital imaging and, more particularly, that of medical digital imaging. Imaging systems designed for medical diagnosis include a variety of types of imaging such as X-ray systems, computed tomodensitometry (CT), ultrasonic systems, electron beam tomography (EBT), magnetic resonance (MR) systems and the like. Imaging systems designed for medical diagnosis generate images of an object such as, for example a patient, exposing the object to a source of radiation such as, for example, a source of X-rays going through a patient. The images generated may be used for several purposes. It is possible, for example, to detect the internal defects of an object. It is also possible to determine the changes in an internal structure or alignment. It is also possible to represent flows of fluid in an object. Furthermore, the image can show the presence or absence of objects in an object. The information obtained from diagnostic imaging can be applied in several fields including medicine and manufacturing.

Through the advances made in techniques of image reconstruction synchronized by electrocardiography, computer tomodensitometry imaging is now giving radiologists reliable views of heart anatomy. The coronary arteries as will as the right and left cavities of the heart are made visible through the intravenous injection of a contrast agent.

The left ventricle and right auricle are separated by the mitral valve. The left ventricle is connected to the ascending aorta through the aortic valve. Several pulmonary veins (generally three to six) are connected to the left auricle. The left cavities are defined as the union of the left auricle and the left ventricle. They do not include the ascending aorta but include the beginning of the pulmonary veins.

In the prior art, satisfactory volume images of the heart muscle and its venous and arterial environment are obtained through the injection of a contrast agent into the patient's blood circulatory system. However, the image resulting from such a radiological examination, which is intended for viewing the patient's heart, also reveals many artifacts that disturb the reading of the volume image. In addition to heart muscle, such a volume image comprises bones (ribs, vertebral column etc.), veins and arteries, and the lung, to mention only the most easily identifiable tissues. Since it is only the heart that interests the practitioner, such an abundance of information is a nuisance and undesirable.

### BRIEF DESCRIPTION OF THE INVENTION

A method for the automatic 3D segmentation of the left cavities has several major applications: (1) it facilitates 3D display. It is far easier to understand the anatomy of the ventricle, the auricle and the ostium of the pulmonary veins in three dimensions (3D) than in two dimensions (2D). Furthermore, an unsegmented view of the left cavities shows many other structures (ribs, lungs, right cavity etc.) that impair the clarity of images of the left cavities by masking their surfaces; (2) knowledge of the contours of the left auricle makes the operations of ablation of the pulmonary veins more reliable; and (3) the segmentation of the left ventricle can be easily deduced from the segmentation of the left cavities, the user being allowed to define the mitral value manually.

An embodiment of the invention resolves these problems by carrying out an automatic segmentation of the left or right cavities of the heart muscle. Once a decision has been made on which cavities are to be isolated, an embodiment of the invention comprises three steps. In a first step, in the volume image resulting from the examination, the volume comprising the heart cavities is determined. In a second step, the left and right cavities are identified. In a third step a precise reconstruction is made of the contours of the left and right cavities for which the segmentation has to be made.

If it is desired to carry out a segmentation of the left cavities, then the method comprises a fourth optional step to remove the image of the aorta of the left cavities, thus giving an image of the heart muscle alone.

### BRIEF DESCRIPTION OF THE DRAWINGS

The invention will be understood more clearly from the following description and the accompanying figures. The figures are given by way of an indication and in no way restrict the scope of the invention. Of these figures:

FIG. 1 illustrates steps of the method of segmentation according to an embodiment of the invention;

FIG. 2 illustrates steps of the method of segmentation according to an embodiment of the invention enabling the separation of the left cavities and the aorta;

FIG. 3 illustrates a structuring element to carry out erosions;

FIG. 4 illustrates a volume image resulting from an examination of the performance of the first thresholding operation according to an embodiment of the invention;

FIG. 5 illustrates a volume image resulting from the first step of the method according to an embodiment of the invention;

FIG. 6 illustrates left cavities segmented by the method according to an embodiment of the invention; and

FIG. 7 illustrates segmented left cavities without aorta obtained by the method of an embodiment of the invention.

### DETAILED DESCRIPTION OF THE INVENTION

In an embodiment of the invention, the steps of automatic segmentation are implemented by a processor unit that belongs to or is connected to a scanner-type radiology apparatus. A processor unit of this kind comprises at least one microprocessor and a set of memories. The steps are therefore implemented by this microprocessor controlled by instruction codes recorded in the memories.

Prior to the implementation of the invention, a practitioner carries out a radiology examination producing a first volume image of the region of the body containing the patient's heart. For the maximum efficiency of the method according to the invention, this first volume image is taken at the 70% mark in the cardiac cycle, which corresponds to the diastole phase.

A volume image is a set, or cloud of dots also known as voxels. Each voxel is characterized by its coordinates in space and a value assigned to it by the scanner. This value is expressed in HU or Houndsfield Units. The HU is a unit proportional to the coefficient of absorption of X-rays by tissues. Each voxel is therefore associated with a value expressed in HU, the dynamic range of such a value being [−1024, 3072]. The lowest values correspond to the least absorbent tissues. The cavities are artificially made more absorbent by the use of a contrast agent injected into the blood.

The first volume image coming from the examination comprises a great deal of information in addition to the information of interest to the practitioner. In the case of the invention, only the information, hence the voxels, corresponding to the left or right cavities of the heart are of interest to the petitioner. At the end of the examination, the first volume image has information not only on the heart but also on the veins, arteries, bones, lungs and other organs located in the vicinity.

In this description, all the volume images have the same spatial dimensions and orientation, and can therefore be superimposed.

FIG. 1 shows step 101 producing a fourth volume image from the first volume image. This fourth volume image no longer contains any information other than that pertaining to the heart cavities. In other words, this fourth volume image enables the voxels of the volume image to be divided into two categories. A first category corresponds to the voxels belonging to the heart cavities, and the second category comprises all the voxels of the first volume image that are not in the first category.

Step 101 can be subdivided into three steps. In step 102, the processor unit carries out a thresholding on the first volume image in keeping only the voxels whose associated value is greater than a first threshold. In an example, this first threshold is equal to 130 HU. In other words, it is considered here that all the voxels having an associated value greater than 130 HU have a non-zero probability of belonging to the heart. This procedure thus isolates the whitest elements of the volume image.

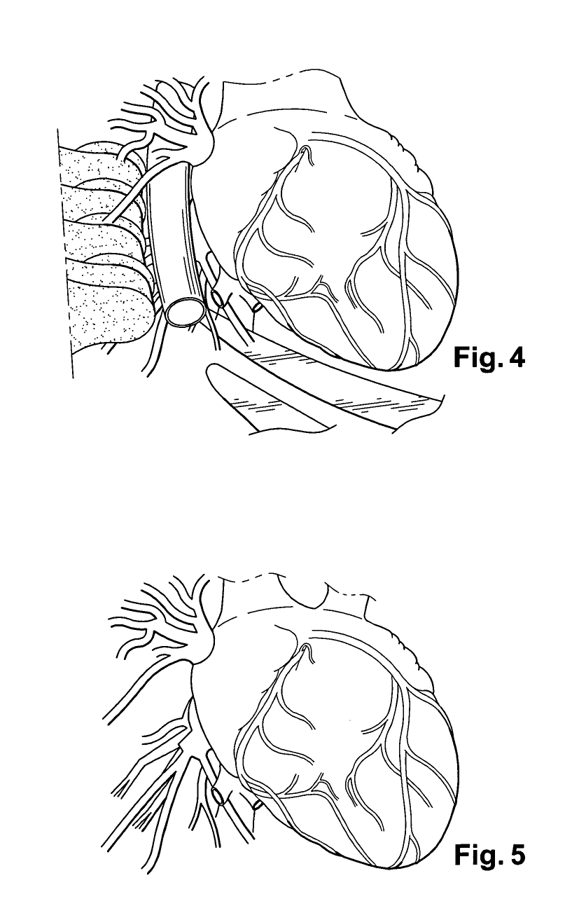

FIG. 4 illustrates the result of this first step that is a second volume image. This second volume image still includes many structures in addition to the heart, especially the bones that absorb X-rays well.

After step 102, the processor unit performs step 103 of erosion of the second volume image. An erosion is a known operation in mathematical morphology in which each voxel is processed by a structuring element. The structuring element is centered on the voxel to be processed and, if the structuring element thus placed has voxels that do not belong to the structure to be eroded, then the voxel is eliminated from the volume image that is the result of the erosion. The term “eliminated” is understood to mean that the voxel is extinguished, namely that the value associated with it is equal to 0. For the invention, the erosion is isotropic. This result, namely isotropic erosion, is obtained for example by the use of a cross-shaped structuring element. FIG. 3 shows a structuring element 300 of this kind. Such a structuring element has three orthogonal arms, each with a length of three voxels, intersecting each other at the middle.

The structures to be eroded are those presented in the second volume image. The result of step 103 is a third volume image with a certain number of structures dissociated from each other, the erosion of step 103 having contributed to dissociating the weakly bound structures. In an embodiment mode of implementation, the erosion of step 103 is equal to two voxels. To carry out this erosion, actually two successive one-voxel erosions are performed with the above-described structuring element.

The structures of the third volume image are also called connected components. A connected component is a set of voxels, each voxel of the set having at least one voxel of said set as its neighbor. In an embodiment the invention, such a set has boundaries that are eliminated points.

In a selection step 104, the processor unit associates a size with each connected component. Such a size is, for example, a number of voxels that the connected component comprises. Once the size of the connected components of the third volume image has been determined, the processor unit selects the largest of them than and eliminates all the others, this producing a fourth volume image comprising only the voxels belonging to the heart cavities. Such a volume image is illustrated by FIG. 5. Such a volume image shows the left and right ventricles, the left and right auricles, the pulmonary veins and the aorta.

Step 104 is the last of the three steps into which step 101 is sub-divided. FIG. 1 shows that step 101 is followed by a step 105 for the separation of the right and left cavities of the heart. Step 105 may comprise several steps.

FIG. 1 has step 106, following step 104, in which the processor unit performs a second thresholding operation in the fourth volume image. This second thresholding operation is performed with a threshold greater than the one used for the first thresholding operation and, in a preferred example, has a value of 160 HU. This thresholding operation then produces a fifth initial volume image.

In sep 107 following step 106, the processor unit performs the successive erosion operations starting from the fifth volume image, each erosion being done on the volume image resulting from the previous erosion. One of the useful aspects of the successive erosion operations is that they prevent the structures that are to be separated from being damaged any more than is necessary.

The successive erosion operations are performed so long as an end-of-iteration criterion has not been reached. In an example, this criterion is the following: for each volume image coming from an erosion, the size of the connected components present in the volume image is measured. Then, the ratio between the two largest connected components is computed. If this ratio is within a predetermined interval, then the erosion operations are interrupted and, in a definitive fifth volume image, only the two largest connected components, whose size ratio has just been computed, are kept. The definitive fifth volume image is the one resulting from the successive erosion operations and is designated hereinafter as the fifth volume image.

In an example, the ratio of the size of the largest connected component to the size of the second largest connected component is computed, and the successive erosions are interrupted when this ratio is smaller than 5. In one variant, this ratio must be smaller than 10, or smaller than a number within the interval [1, 10].

Once the end-of-iteration criterion has been attained, the processor unit eliminates all the components that are not the two largest connected components. A fifth volume image is then obtained, comprising no more than two connected components.

Step 107 may be followed by step 108 for the identification of the connected components selected at step 107. This step considers the fifth volume image that is oriented. This orientation is the one resulting from the examination that produced the first volume image. Thus, the height of a volume image corresponds to the upper part of the body from which the volume image has been produced, this height being taken when the body of the individual is upright. The left side of a volume image corresponds to the left side of the body from which the volume image has been produced, considered when the individual is being looked at from the front. These two pieces of information make it possible to totally orient a volume image.

In step 107, and in a variant embodiment, the processor unit computes the center of gravity of one of the two connected components remaining at the end of the step 107. Then the processor unit considers a horizontal straight line passing through this center of gravity and passes over this straight line from left to right, the left and the right directions being those of a person facing the patient. During this passage, the first connected component encountered, between the two components remaining at the end of step 107, corresponds to the left cavities of the heart.

In another variant embodiment, at step 107, the processor unit computes the centers of gravity of the two connected components coming from step 107. The relative position of these two centers of gravity then enables the identification of the connected components, hence that of the heart cavities. The center of gravity located at the highest position corresponds to the connected component belonging to the right cavities of the heart.

At the end of step 108, the two connected components resulting from step 107 are each identified as belonging either to the left cavities or to the right cavities.

Step 105 is followed by a step 109 to reconstruct the contours of the heart cavities. Step 105 may comprise several steps.

FIG. 1 shows that a step 108 is followed by step 110 for computing the gradient image of the fourth volume image. This gradient image is a sixth volume image. The sixth volume image is obtained from the fourth volume image by the application of a gradient filter.

Step 110 is followed by a step 111 for the application of the watershed algorithm to the sixth volume image. This algorithm is applied by using the two connected components derived from the step 108 as seeds. One seed therefore corresponds to the left cavities, the other seed corresponding to the right cavities.

The seed-based watershed algorithm can be seen as a simulation of flooding. The term “watershed” comes from the manner in which the algorithm segments the regions of a volume into basins. These basins are initially the low-intensity points in the volume to be segmented. These basins share boundaries with one another. Let us imagine that there is rainfall in these basins. The water level will then rise. As and when the water level rises, the basins get filled and finally overflow their boundaries to form increasingly bigger basins.

In an embodiment of the invention, the segmented image is a gradient image. This has the effect of reinforcing the contours of the objects present in the image while at the same time hollowing out the interior of these objects. The seeds used in the invention correspond to the interior of the object to be segmented, and it is from these seeds that the flooding is carried out. In other words, these seeds are the first basins, each of these two first basins being associated with a label or tag. During the flooding, every new basin that comes into contact with one of these two first basins acquires the tag of this basin. The flooding process, hence the watershed algorithm, stops when each voxel is assigned a tag. In the invention, the flooding is bounded by the connected component of the fourth volume image. In other words, the flooding process assigns a tag only to the voxels of this connected component.

At the end of step 111, all the voxels of the connected component of the fourth volume image are assigned a tag, through the segmentation of the sixth volume image. Hence, at the end of step 111, a voxel that is not eliminated from the fourth volume image belongs either to the right cavities or to the left cavities of the heart. An embodiment of the invention than continues to a selection step 112 for the elimination of all the voxels corresponding to only one of the tags depending on whether it is desired to obtain an image of the left cavities or of the right cavities. The coordinates of the voxels that are not eliminated are known. This knowledge enables the extraction, from the third volume image, of the information on intensity corresponding to the voxels and thus enables the production of an eighth volume image.

At the end of step 112, there is then the eighth volume image comprising only voxels corresponding to the heart cavities that are to be viewed. It can also be said that the heart cavities, whether right or left, have been isolated. This selection is made as a function of a parametrizing operation performed by a practitioner prior to the step 101. This parametrizing operation comprises designating the cavities, left or right, which the practitioner wishes to isolate. The processor unit then uses this designation, left or right, as the criterion of selection in step 112.

In a variant embodiment, step 112 is followed by an expansion step 113. An expansion is an operation that is the reverse of an erosion. The expansion applied at step 113 has a size equal to the size of the erosion made at step 103. In this variant embodiment, the processor unit therefore saves the parameters of the first erosion of step 103 in a memory. This expansion enables the retrieval of the information that had been eliminated at step 103 for the sake of robustness. This expansion is therefore done with the same structuring element as the one used for step 103, and comprises the same number of passes. Since, in the example, the erosion of step 103 is formed by two one-voxel erosions, the expansion of step 113 is formed by two one-voxel expansions. This expansion therefore enables the retrieval, in the first volume image, of voxels that are neighbors, in the sense of the expansion, of the structure isolated in the eighth volume image.

In a variant embodiment, the end of step 113 is also the end of step 109. At the end of this step 109, a practitioner therefore has a volume image, designated in this description as being the ninth volume image, which no longer has voxels other than those corresponding to the left cavities of the heart. In the present example, it is assumed that the practitioner acting on the processor unit wishes to isolate the left cavities of the heart and therefore that, in step 112, he selects the tag corresponding to the left cavities.

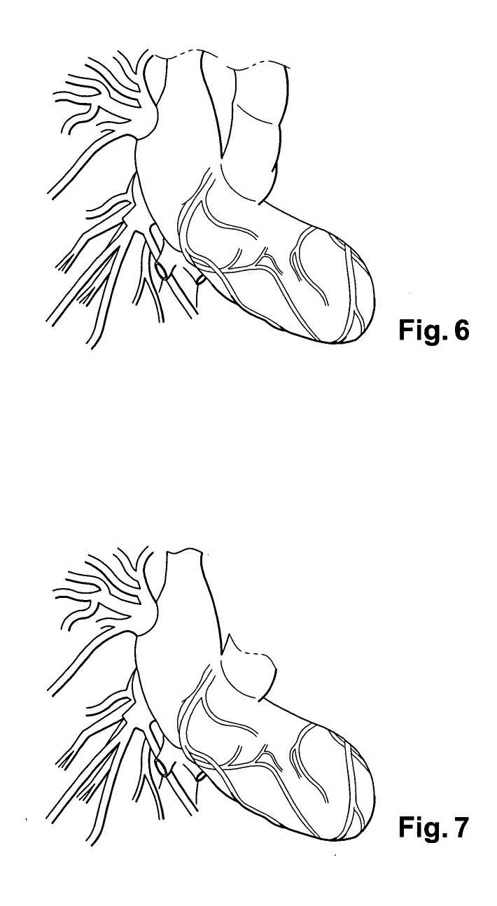

The ninth volume image is illustrated by FIG. 6. FIG. 6 shows a volume image comprising information on the left auricle and left ventricle, the pulmonary veins and the aorta.

If the practitioner had selected the tag corresponding to the right cavities, then the method according to an embodiment would have been terminated.

However, in the case of the left cavities, step 109 is followed by a step 200 for eliminating the aorta. Step 200 may comprise several steps.

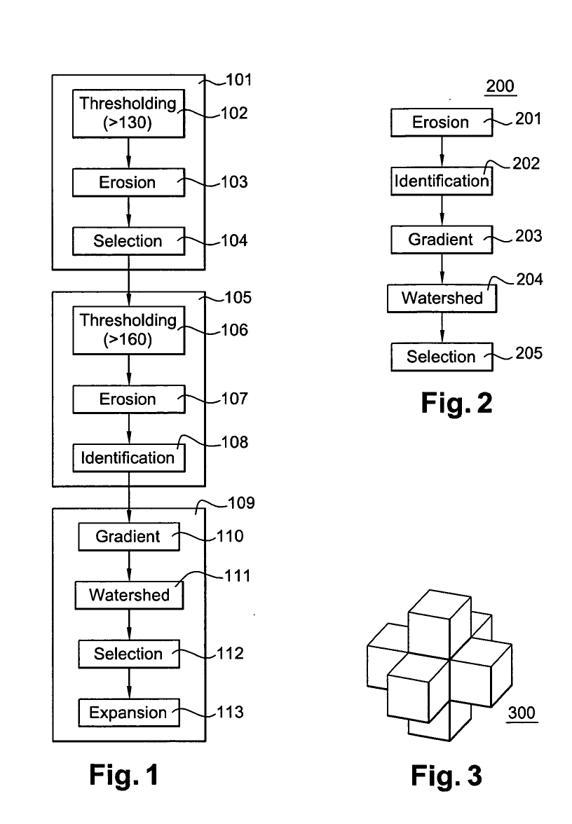

FIG. 2 shows that step 200 comprises a first step 201 for performing a third erosion that is a strong erosion. This third erosion is performed on the ninth volume image. This strong third erosion is a ten-voxel erosion. As above, this strong erosion is in fact done by 10 small one-voxel erosions. The result of this strong erosion is the 10th volume image. The 10th volume image comprises a cloud of voxels consisting of voxels that have not been eliminated by the strong erosion.

Step 201 is followed by a step 202 for the identification of two distinct voxels belonging respectively to the aorta and to the left ventricle in the 10th volume image. This identification is done through the orientation of the volume image. The voxel of the cloud of voxels of the 10th volume image that is located at the highest position and is closest to the front of the patient, namely closest to his ribs, belongs to the aorta, while the voxel at the lowest position belongs to the left ventricle.

Step 201 is also followed by a step 203 in which the processor unit computes the gradient image of the ninth volume image. The result of step 203 is an 11th volume image.

Once steps 202 and 203 have been performed, the processor unit passes to a step 204 for implementing the watershed algorithm on the 11th volume image in using the voxels identified at step 202 as seeds.

The implementation of step 204 is identical to the implementation of step 111, except that it uses neither the same initial image nor the same seeds.

The result of step 204 is a 12th volume image corresponding to the ninth volume image segmented into two parts: one part corresponding to the aorta and the other part corresponding to the left ventricle and left auricle. At the end of step 204, each of the voxels not eliminated from the 11th volume image belongs either to the aorta or to the left ventricle and left auricle.

Step 204 is followed by a selection step 205 identical to step 112, except that this time the selection criterion pertains to the extraction of only the voxels corresponding to the left ventricle and left auricle. In step 205, the part corresponding to the aorta is therefore eliminated, thus enabling the production of a 13th volume image, illustrated in FIG. 7, comprising only the left ventricle and the left auricle.

This 13th volume image is particularly useful in electrophysiology. In this field, certain individuals show a disturbing signal that arises in the pulmonary veins. This signal give rise to arrhythmia that must be corrected by an ablation of the pulmonary veins. The 13th volume image is particularly well suited to the preparation of this ablation because it preserves only those parts of the heart that are concerned by the operation.

An embodiment of the invention is also useful in the measurement of blood circulation rates, and especially in the measurement of the ejection fraction of the ventricles.

An embodiment of the invention is a method for the segmentation of a part of the heart in a first volume image corresponding to a region of the body containing the heart, wherein the method comprises steps implemented by a processor unit.

In a first step for isolating the heart in the first volume image, this first step comprising the following steps: a step for a first thresholding of the first volume image at a predefined level so as to isolate the whitest elements of the volume image, this step producing a second volume image; a step for carrying out a first erosion of the second volume image, this step producing a third volume image; and a step for the selection, in the third volume image, of the largest connected component, this component then corresponding to the heart, this step producing a fourth volume image.

In a second step for the separation, in the fourth volume image, of the left heart cavities from the right heart cavities, this second step comprising the following steps: a step for the second thresholding of the fourth volume image with a predefined level higher than the level for the first thresholding operation; a step in which successive erosions are made on the fourth thresholded volume image until there is obtained an image comprising two connected components that are main connected components in terms of size, for which the ratio of the sizes is within in a predefined interval, this step producing a fifth volume image; and a step for identifying main connected components in the fifth volume image.

In a third step for the reconstruction of the main contours of the main connected components, this third step comprising the following steps: a step to compute the gradient of the fourth volume image, this step producing a sixth volume image; a step for the application of the watershed algorithm to the sixth volume image, this application being made by using the identified main connected components as seeds for the algorithm, this step producing a seventh volume image; a step for the selection, in the seventh volume image, of the element obtained from the processing by the watershed algorithm corresponding to the seed that had been identified as forming part of the cavities that a practitioner seeks to isolate, this selection enabling the extraction, from the third volume image, of the voxels corresponding to the cavities that the practitioner seeks to isolate, this step producing an eighth volume image of the isolated cavities; and a step of expansion carried out on the eighth image, this expansion having a size equal to that of the first erosion, this step producing a ninth volume image.

In an embodiment of the invention if the cavities that the practitioner seeks to isolate are left cavities, the method then comprising the following steps: a step for making a third strong erosion on the ninth volume image, this step producing a 10th volume image; a step for identifying two distinct points belonging respectively to the aorta and to the left ventricle in the cloud of voxels resulting from the third erosion, the voxel located at the highest position in this cloud of voxels corresponding to the aorta while the voxels located at the lowest position corresponds to the left ventricle; a step to compute the gradient of the ninth volume image, this step producing an 11th volume image; a step to apply the watershed algorithm to the 11th volume image, this application being done by using the two voxels identified at the identification step as a seed for the algorithm, this step producing a 12th volume image; a step for the selection, in the 12th volume image, of the element resulting from the processing by the watershed algorithm and corresponding to the seed that has been identified as forming part of the left cavities, this selection enabling the extraction, from the first volume image, of the voxels corresponding to the left cavities, this step producing a 13th volume image of the left cavities without the aorta.

In an embodiment of the invention the first thresholding operation is equal to 130 HU on a scale ranging from −1024 to 4096. In an embodiment of the invention for the erosions, the structuring elements are crosses. In an embodiment of the invention the first erosion is an erosion of the order of 2 voxels. In an embodiment of the invention the successive erosions are performed by a structuring element enabling in erosion of the order of 1 voxel. In an embodiment of the invention the ratio of the size of the largest of the main connected components to the size of the smallest of the main connected components is contained in the interval [1, 10]. In an embodiment of the invention the threshold of the second thresholding operation is equal to 160 HU on a scale ranging from −1024 to 4096.

In an embodiment of the invention the identification of the main connected components is done by the computation of at least the center of gravity of one of the main connected components, wherein a horizontal straight line, when facing the patient, passes through the center of gravity and then interrupts first the right cavities.

In an embodiment of the invention the heart cavities selected are the left cavities.

In an embodiment of the invention is the third erosion is an erosion of the order of 10 voxels.

One skilled in the art may make or propose various modifications to the structure/way and/or function and/or results and/or steps of the disclosed embodiments and equivalents thereof without departing from the scope and extant of the invention.

1. A method for the segmentation of a part of the heart in a first volume image corresponding to a region of the body containing the heart, wherein the method comprises:
a first step for isolating the heart in the first volume image, this first step comprising the following steps:
a step for a first thresholding of the first volume image at a predefined level so as to isolate the whitest elements of the volume image, this step producing a second volume image;
a step for carrying out a first erosion of the second volume image, this step producing a third volume image; and
a step for the selection, in the third volume image, of the largest connected component, this component then corresponding to the heart, this step producing a fourth volume image;
a second step for the separation, in the fourth volume image, of the left heart cavities from the right heart cavities, this second step comprising the following steps:
a) step for the second thresholding of the fourth volume image with a predefined level higher than the level for the first thresholding operation;
a step in which successive erosions are made on the fourth thresholded volume image until there is obtained an image comprising two connected components that are main connected components in terms of size, for which the ratio of the sizes is within in a predefined interval, this step producing a fifth volume image; and
a step for identifying main connected components in the fifth volume image;
a third step for the reconstruction of the main contours of the main connected components, this third step comprising the following steps:
a step to compute the gradient of the fourth volume image, this step producing a sixth volume image;
a step for the application of the watershed algorithm to the sixth volume image, this application being made by using the identified main connected components as seeds for the algorithm, this step producing a seventh volume image;
a step for the selection, in the seventh volume image, of the element obtained from the processing by the watershed algorithm corresponding to the seed that had been identified as forming part of the cavities that a practitioner seeks to isolate, this selection enabling the extraction, from the third volume image, of the voxels corresponding to the cavities that the practitioner seeks to isolate, this step producing an eighth volume image of the isolated cavities; and
a step of expansion carried out on the eighth image, this expansion having a size equal to that of the first erosion, this step producing a ninth volume image.

2. The method according to claim 1 wherein the cavities that the practitioner seeks to isolate are left cavities comprising:
a step for making a third strong erosion on the ninth volume image, this step producing a tenth volume image;
a step for identifying two distinct points belonging respectively to the aorta and to the left ventricle in the cloud of voxels resulting from the third erosion, the voxel located at the highest position in this cloud of voxels corresponding to the aorta while the voxel located at the lowest position corresponds to the left ventricle;
a step to compute the gradient of the ninth volume image, this step producing an eleventh volume image;
a step to apply the watershed algorithm to the eleventh volume image, this application being done by using the two voxels identified at the identification step as a seed for the algorithm, this step producing a twelfth volume image; and
a step for the selection, in the twelfth volume image, of the element resulting from the processing by the watershed algorithm and corresponding to the seed that has been identified as forming part of the left cavities, this selection enabling the extraction, from the first volume image, of the voxels corresponding to the left cavities, this step producing a thirteenth volume image of the left cavities without the aorta.

3. The method according to claim 1 wherein the threshold of the first thresholding operation is equal to 130 HU on a scale ranging from −1024 to 4096.

4. The method according to claim 2 wherein the threshold of the first thresholding operation is equal to 130 HU on a scale ranging from −1024 to 4096.

5. The method according to claim 1 wherein for the erosions, the structuring elements are crosses.

6. The method according to claim 2 wherein for the erosions, the structuring elements are crosses.

7. The method according to claim 3 wherein for the erosions, the structuring elements are crosses.

8. The method according to claim 1 wherein the first erosion is an erosion of the order of two voxels.

9. The method according to claim 2 wherein the first erosion is an erosion of the order of two voxels.

10. The method according to claim 3 wherein the first erosion is an erosion of the order of two voxels.

11. The method according to claim 5 wherein the first erosion is an erosion of the order of two voxels.

12. The method according to claim 1 wherein the successive erosions are performed by a structuring element enabling in erosion of the order of one voxel.

13. The method according to claim 2 wherein the successive erosions are performed by a structuring element enabling in erosion of the order of one voxel.

14. The method according to claim 3 wherein the successive erosions are performed by a structuring element enabling in erosion of the order of one voxel.

15. The method according to claim 5 wherein the successive erosions are performed by a structuring element enabling in erosion of the order of one voxel.

16. The method according to claim 8 wherein the successive erosions are performed by a structuring element enabling in erosion of the order of one voxel.

17. The method according to claim 1 wherein the ratio of the size of the largest of the main connected components to the size of the smallest of the main connected components is contained in the interval [1, 10].

18. The method according to claim 2 wherein the ratio of the size of the largest of the main connected components to the size of the smallest of the main connected components is contained in the interval [1, 10].

19. The method according to claim 3 wherein the ratio of the size of the largest of the main connected components to the size of the smallest of the main connected components is contained in the interval [1, 10].

20. The method according to claim 5 wherein the ratio of the size of the largest of the main connected components to the size of the smallest of the main connected components is contained in the interval [1, 10].

21. The method according to claim 8 wherein the ratio of the size of the largest of the main connected components to the size of the smallest of the main connected components is contained in the interval [1, 10].

22. The method according to claim 12 wherein the ratio of the size of the largest of the main connected components to the size of the smallest of the main connected components is contained in the interval [1, 10].

23. The method according to claim 1 wherein the threshold for the second thresholding operation is equal to 160 HU on a scale ranging from −1024 to 4096.

24. The method according to claim 2 wherein the threshold for the second thresholding operation is equal to 160 HU on a scale ranging from −1024 to 4096.

25. The method according to claim 3 wherein the threshold for the second thresholding operation is equal to 160 HU on a scale ranging from −1024 to 4096.

26. The method according to claim 5 wherein the threshold for the second thresholding operation is equal to 160 HU on a scale ranging from −1024 to 4096.

27. The method according to claim 8 wherein the threshold for the second thresholding operation is equal to 160 HU on a scale ranging from −1024 to 4096.

28. The method according to claim 12 wherein the threshold for the second thresholding operation is equal to 160 HU on a scale ranging from −1024 to 4096.

29. The method according to claim 17 wherein the threshold for the second thresholding operation is equal to 160 HU on a scale ranging from −1024 to 4096.

30. The method according to claim 1 wherein the identification of the main connected components is done by the computation of at least the center of gravity of one of the main connected components, wherein a horizontal straight line, considered in a position facing when the patient, passes through the center of gravity and then intercepts the right cavities first.

31. The method according to claim 2 wherein the identification of the main connected components is done by the computation of at least the center of gravity of one of the main connected components, wherein a horizontal straight line, considered in a position facing when the patient, passes through the center of gravity and then intercepts the right cavities first.

32. The method according to claim 3 wherein the identification of the main connected components is done by the computation of at least the center of gravity of one of the main connected components, wherein a horizontal straight line, considered in a position facing when the patient, passes through the center of gravity and then intercepts the right cavities first.

33. The method according to claim 5 wherein the identification of the main connected components is done by the computation of at least the center of gravity of one of the main connected components, wherein a horizontal straight line, considered in a position facing when the patient, passes through the center of gravity and then intercepts the right cavities first.

34. The method according to claim 8 wherein the identification of the main connected components is done by the computation of at least the center of gravity of one of the main connected components, wherein a horizontal straight line, considered in a position facing when the patient, passes through the center of gravity and then intercepts the right cavities first.

35. The method according to claim 12 wherein the identification of the main connected components is done by the computation of at least the center of gravity of one of the main connected components, wherein a horizontal straight line, considered in a position facing when the patient, passes through the center of gravity and then intercepts the right cavities first.

36. The method according to claim 17 wherein the identification of the main connected components is done by the computation of at least the center of gravity of one of the main connected components, wherein a horizontal straight line, considered in a position facing when the patient, passes through the center of gravity and then intercepts the right cavities first.

37. The method according to claim 23 wherein the identification of the main connected components is done by the computation of at least the center of gravity of one of the main connected components, wherein a horizontal straight line, considered in a position facing when the patient, passes through the center of gravity and then intercepts the right cavities first.

38. The method according to claim 1 wherein the heart cavities selected is the left cavities.

39. The method according to claim 2 wherein the heart cavities selected is the left cavities.

40. The method according to claim 3 wherein the heart cavities selected is the left cavities.

41. The method according to claim 5 wherein the heart cavities selected is the left cavities.

42. The method according to claim 8 wherein the heart cavities selected is the left cavities.

43. The method according to claim 12 wherein the heart cavities selected is the left cavities.

44. The method according to claim 17 wherein the heart cavities selected is the left cavities.

45. The method according to claim 23 wherein the heart cavities selected is the left cavities.

46. The method according to claim 30 wherein the heart cavities selected is the left cavities.

47. The method according to claim 2 wherein the third erosion is an erosion of the order of 10 voxels.

48. The method according to claim 3 wherein the third erosion is an erosion of the order of 10 voxels.

49. The method according to claim 5 wherein the third erosion is an erosion of the order of 10 voxels.

50. The method according to claim 8 wherein the third erosion is an erosion of the order of 10 voxels.

51. The method according to claim 12 wherein the third erosion is an erosion of the order of 10 voxels.

52. The method according to claim 17 wherein the third erosion is an erosion of the order of 10 voxels.

53. The method according to claim 23 wherein the third erosion is an erosion of the order of 10 voxels.

54. The method according to claim 30 wherein the third erosion is an erosion of the order of 10 voxels.

55. The method according to claim 38 wherein the third erosion is an erosion of the order of 10 voxels.

56. A computer program comprising program code means for implementing the steps of the method according to claim 1.

57. A computer program product comprising a computer useable medium having computer readable program code means embodied in the medium, the computer readable program code means implementing the steps of the method according to claim 1.

58. An article of manufacture for use with a computer system, the article of manufacture comprising a computer readable medium having computer readable program code means embodied in the medium, the program code means implementing the steps of the method according to claim 1.

59. A program storage device readable by a machine tangibly embodying a program of instructions executable by the machine to perform the steps of the method according to claim 1.

60. A generated or stored signal or transmitted or a received signal, the signal embodying a program of instructions executable by a machine to perform the steps of the method according to claim 1.
